(19) United States
(12) Patent Application Publication
(10) Pub. No.: US 2008/0246386 A1
(43) Pub. Date: Oct. 9, 2008

(54) ELECTRODE SHEET FOR PLASMA DISPLAY PANEL AND PLASMA DISPLAY PANEL USING THE SAME

(76) Inventors: Byoung-Min Chun, Suwon-si (KR); Seong-Gi Choo, Suwon-si (KR); Won-Yi Lee, Suwon-si (KR); Kyoung-Doo Kang, Suwon-si (KR); Yong-Shik Hwang, Suwon-si (KR); Tae-Seung Cho, Suwon-si (KR); Jong-Woo Choi, Suwon-si (KR); Seok-Gyun Woo, Suwon-si (KR); Atti Choi, Suwon-si (KR); Jae-Ik Kwon, Suwon-si (KR); Hyun-Min Son, Suwon-si (KR)

Correspondence Address: CHRISTIE, PARKER & HALE, LLP, PO BOX 7068, PASADENA, CA, 91109-7068, US

(21) Appl. No.: 12/061,550

(22) Filed: Apr. 2, 2008

(30) Foreign Application Priority Data
Apr. 6, 2007 (KR) 10-2007-0034097

(51) Int. Cl. H01J 1/62; H01J 9/02

(52) U.S. Cl. 313/491; 445/47

(57) ABSTRACT

An electrode sheet for a plasma display panel and a plasma display panel utilizing the same. The electrode sheet for the plasma display panel includes: a dielectric layer having a first surface and a second surface and including a discharge hole for providing a side wall of a discharge space, the dielectric layer being composed of metal oxide (MxOy); and a discharge electrode including a discharge unit around a perimeter of the discharge hole and a connection unit for connecting the discharge unit and another discharge unit to each other, the discharge electrode being within the dielectric layer and composed of metal (M) of the metal oxide (MxOy). Here, the discharge unit of the discharge electrode is within the dielectric layer such that the first surface of the dielectric layer has an area differing from that of the second surface of the dielectric layer.

### CROSS-REFERENCE TO RELATED APPLICATIONS

This application claims priority to and the benefit of Korean Patent Application No. 2007-0034097, filed on Apr. 6, 2007, in the Korean Intellectual Property Office, the entire content of which is incorporated herein by reference.

### BACKGROUND

1. Field of the Invention

The present invention relates to a plasma display panel, and more particularly to an electrode configuration of a plasma display panel.

2. Description of the Related Art

A typical modern plasma display panel may be classified according to one of three groups, including a DC plasma display panel, an AC plasma display panel and a hybrid plasma display panel, depending on the applied discharge voltage, and also classified as an opposed discharge plasma display panel or a surface discharge plasma display panel, depending on the discharge type.

A DC plasma display panel has a structure in which all electrodes are exposed to a discharge space, and electric charges are directly transferred between the corresponding electrodes. An AC plasma display panel has at least one electrode surrounded by a dielectric layer, wherein electric charges are not directly transferred between the corresponding electrodes but a discharge is carried out by utilizing a wall charge field.

In a DC plasma display panel, the electrodes may be severely damaged because the electric charges are directly transferred between the corresponding electrodes. Therefore, AC plasma display panels have been widely used in recent years.

In AC plasma display panels, a three-electrode surface discharge structure has been used. Here, the structure surrounding a discharge space is composed of a front glass substrate, a rear glass substrate and a barrier rib, and includes an address electrode, an X electrode and a Y electrode arranged therein.

However, AC plasma display panels have the problems of a high address discharge voltage and an address voltage that is slowly sustained due to a discharge path between the address electrode and the X electrode or Y electrode being long during an address discharge.

### SUMMARY OF THE INVENTION

Aspects of embodiments of the present invention are directed toward an electrode sheet for a plasma display panel having an AC electrode structure capable of preventing (or reducing) an erroneous discharge caused outside discharge cells; and a plasma display panel utilizing the same.

An embodiment of the present invention provides an electrode sheet for a plasma display panel, the electrode sheet including: a dielectric layer having a first surface and a second surface and including a discharge hole for providing a side wall of a discharge space, the dielectric layer being composed of metal oxide (MxOy); and a discharge electrode including a discharge unit around a perimeter of the discharge hole and a connection unit for connecting the discharge unit and another discharge unit to each other, the discharge electrode being within the dielectric layer and composed of metal (M) of the metal oxide (MxOy), wherein the discharge unit of the discharge electrode is within the dielectric layer such that the first surface of the dielectric layer has an area differing from that of the second surface of the dielectric layer.

In one embodiment, a first surface of the discharge electrode corresponding to the first surface of the dielectric layer is larger in area than that of a second surface of the discharge electrode corresponding to the second surface of the dielectric layer.

In one embodiment, the discharge hole has a reverse-tapered shape.

In one embodiment, the metal (M) is selected from the group consisting of aluminum and its alloys.

In one embodiment, the connection unit and the discharge unit of the discharge electrode have substantially the same thickness.

In one embodiment, the first surface of the dielectric layer is a lower surface of the dielectric layer, and the second surface of the dielectric layer is an upper surface of the dielectric layer.

Another embodiment of the present invention provides a plasma display panel including: a rear glass substrate; a front glass substrate facing and spaced from the rear glass substrate at a constant distance, a first electrode sheet, and a second electrode sheet. The first electrode sheet including: a first dielectric layer between the rear glass substrate and the front glass substrate and including a first discharge hole for providing a side wall of a discharge space, the first dielectric layer being composed of metal oxide (MxOy), and a first discharge electrode within the first dielectric layer and including a first discharge unit around a perimeter of the first discharge hole and a first connection unit for connecting the first discharge unit and another first discharge unit to each other, the first discharge electrode being composed of metal (M) of the metal oxide (MxOy). The second electrode sheet including: a second dielectric layer between the first electrode sheet and the front glass substrate and including a second discharge hole arranged in a facing region to correspond to the first discharge hole, the second discharge hole being also for providing the side wall of the discharge space, and a second discharge electrode within the second dielectric layer and including a second discharge unit around a perimeter of the second discharge hole and a second connection unit for connecting the second discharge unit and another second discharge unit to each other, the second discharge electrode being composed of metal (M) of the metal oxide (MxOy). Here, a lower surface of the first electrode sheet adjacent to the rear glass substrate has a larger area than an upper surface of the first electrode sheet adjacent to the second dielectric layer, a lower surface of the second electrode sheet adjacent to the first dielectric layer has a smaller area than the upper surface of the first electrode sheet, and an upper surface of the second electrode sheet has a smaller area than the lower surface of the second electrode sheet.

In one embodiment, at least one of the first discharge hole or the second discharge hole has a reverse-tapered shape.

In one embodiment, a ratio of the area of the upper surface of the second electrode sheet and the area of the lower surface of the first electrode sheet ranges from about 0.3:1 to about 0.9:1. The ratio of the area of the upper surface of the second electrode sheet and the area of the lower surface of the first electrode sheet may be about 0.5:1.

In one embodiment, the first dielectric layer and the second dielectric layer are metal oxides (MxOy) of the metal (M).

In one embodiment, the metal (M) of the first discharge electrode is selected from the group consisting of aluminum and its alloys.

In one embodiment, the metal (M) of the second discharge electrode is selected from the group consisting of aluminum and its alloys.

In one embodiment, the first connection unit and the first discharge unit of the first discharge electrode have substantially the same thickness.

In one embodiment, each of the first discharge hole and the second discharge hole has a reverse-tapered shape.

Another embodiment of the present invention provides a method of manufacturing an electrode sheet for a plasma display panel including a discharge electrode within a dielectric layer, the discharge electrode including a discharge hole, a discharge unit around a perimeter of the discharge hole, and a connection unit for connecting the discharge unit and another discharge unit to each other, the discharge unit being formed so that a first surface of the discharge electrode has an area differing from that of a second surface of the discharge electrode. The method includes: providing a metal sheet; attaching a protective film for forming a pattern of the discharge electrode to one surface of the metal sheet; forming the discharge hole on the metal sheet, the discharge hole having a reverse-tapered shape; detaching the protective film; and anodizing the metal sheet to form the discharge electrode with the dielectric layer and having the first surface with a first surface area and the second surface with a second surface area.

In one embodiment, the forming the discharge hole on the metal sheet includes etching from the one surface of the metal sheet where the protective file of the metal sheet is attached to form the discharge hole having the reverse-tapered shape.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective schematic showing a plasma display panel according to an embodiment of the present invention.

FIG. 2A is a perspective schematic of the first electrode sheet of FIG. 1.

FIG. 2B is a detail schematic of a discharge hole of the first electrode sheet of FIG. 1.

FIG. 2C is a cross-sectional schematic taken at line A-A′ as shown in FIG. 2B.

FIG. 2D is a cross-sectional schematic taken at line B-B′ as shown in FIG. 2B.

FIG. 3A is a perspective schematic of the second electrode sheet of FIG. 1.

FIG. 3B is a detail schematic of a discharge hole of the second electrode sheet of FIG. 1.

FIG. 3C is a cross-sectional schematic taken at line A-A′ as shown in FIG. 3B.

FIG. 3D is a cross-sectional schematic taken at line B-B′ as shown in FIG. 3B.

FIG. 4 is a cross-sectional schematic showing a plasma display panel including a first discharge electrode and a second discharge electrode having no extrusion formed therein.

FIG. 5 is a cross-sectional schematic showing a laminated structure of the first electrode sheet of FIG. 1 and the second electrode sheet of FIG. 1.

FIGS. 6A, 6B, 6C, and 6D are cross-sectional schematics illustrating a method of manufacturing a plasma display panel according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, when one element is connected to another element or referred to as being “on” another element, one element may be directly connected to or on the another element or indirectly connected to or on the another element with one or more intervening elements connected or interposed therebetween. Like reference numerals designate like elements throughout the specification.

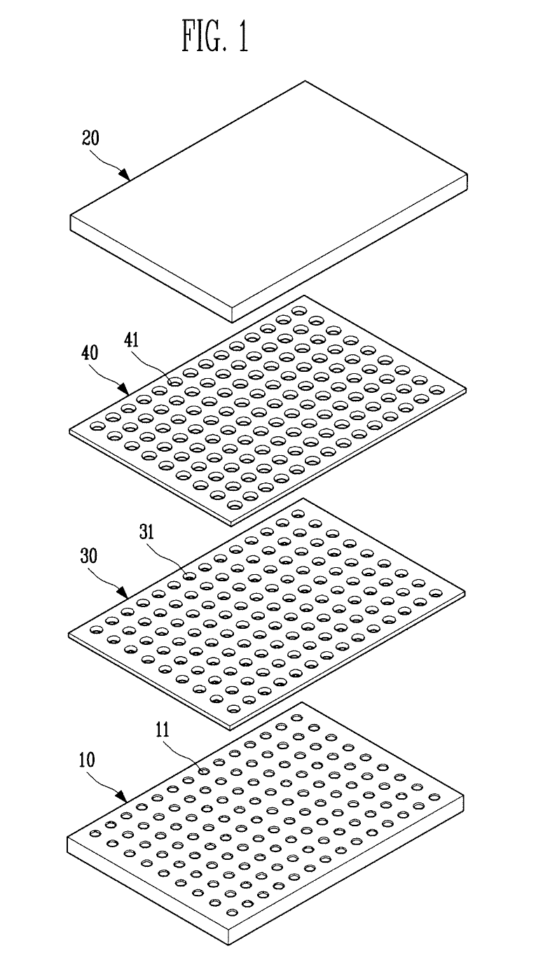

With reference to FIG. 1, a plasma display panel, according to an embodiment of the present invention, includes a rear glass substrate 10, a front glass substrate 20, a first electrode sheet 30, and a second electrode sheet 40.

The rear glass substrate 10 and the front glass substrate 20 are spaced at a substantially constant distance apart, and the first electrode sheet 30 and the second electrode sheet 40 are between the rear glass substrate 10 and the front glass substrate 20. The first electrode sheet 30 is formed on (or adjacent to) the rear glass substrate 10, and the second electrode sheet 40 is formed on (or adjacent to) the front glass substrate 20.

A plurality of first discharge holes 31 are formed in the first electrode sheet 30, and a plurality of second discharge holes 41 are formed in the second electrode sheet 40, the first discharge holes 31 and the second discharge holes 41 facing and corresponding to each other. The first discharge holes 31 and the second discharge holes 41 are connected (above and/or below) to each other, and, in one embodiment, are formed having a reverse tapered shape.

Accordingly, in the present embodiment, a discharge space is formed having a bottom surface including the rear glass substrate 10, a top surface including the front glass substrate 20, an inner wall surface including each of the plurality of first and second discharge holes 31, 41, and containing a discharge gas therein. In one embodiment, a phosphor layer is provided in a recess 11 formed by etching the rear glass substrate 10 at a set (or predetermined) depth.

According to the described embodiment, a discharge between a first discharge electrode provided inside the first electrode sheet 30 and a second discharge electrode provided in the second electrode sheet 40 is carried out from an external power source to drive the plasma display panel.

For example, if the power source is applied to the first discharge electrode and the second discharge electrode, the first discharge electrode serves as scan and Y electrodes, and the second discharge electrode serves as address and X electrodes in order to drive the plasma display panel.

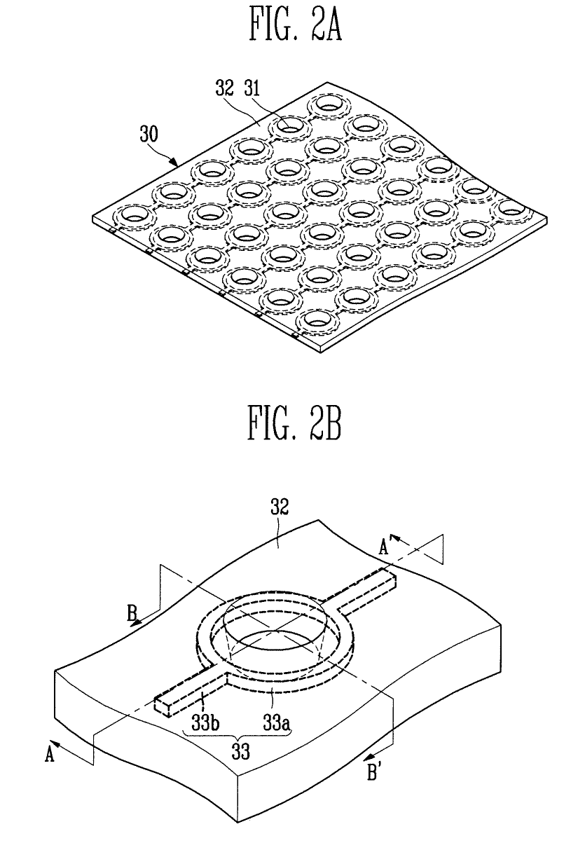

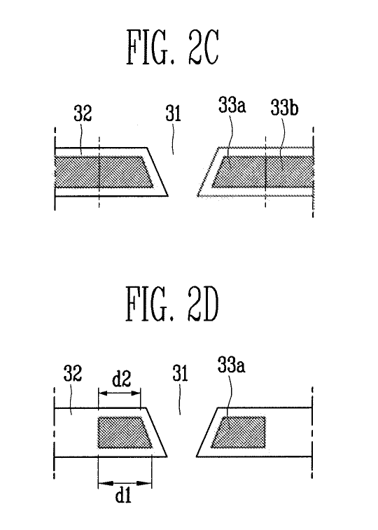

With reference to FIGS. 2A to 2D, the first electrode sheet 30 includes a first dielectric layer 32 and a first discharge electrode 33. The first dielectric layer 32 is a layer for burying (or covering) the first discharge electrode 33 therein, and has the above-mentioned first discharge holes 31. The first dielectric layer 32 is composed of a metal oxide (MxOy) of a metal (M) (e.g., Al₂O₃).

The first discharge electrode 33 is an electrode configured to supply a power of a power source to discharge cells, is within an interior of the first electrode sheet 30 around the first discharge holes 31, and is not exposed to a surface of the first discharge holes 31. The first discharge electrode 33 includes a first discharge unit 33a and a first connection unit 33b. The first discharge unit 33a is configured as a closed curve, wherein the closed curve surrounds one of the first discharge holes 31. The first connection unit 33b is configured to connect the first discharge units 33a, to receive a power from an external power source, and to supply the received external power source to the first discharge electrode 33. In one embodiment, the first discharge electrode 33 is composed of the same metal as the metal (M) of the metal oxide (MxOy) which is a material of the first dielectric layer 32. Also, according to one embodiment, a plurality of the first discharge electrodes 33 generally extend in one direction.

The second discharge electrode 43 is an electrode configured to react with the first discharge electrode 33 to cause a discharge, wherein the first and second discharge electrodes 33, 43 play complementary roles. For example, if the first discharge electrode 33 serves as a scan electrode during an address period and serves as a Y electrode during a sustain period in driving an electrode sheet, the second discharge electrode 43 serves as an address electrode during the address period and serves as an X electrode during the sustain period.

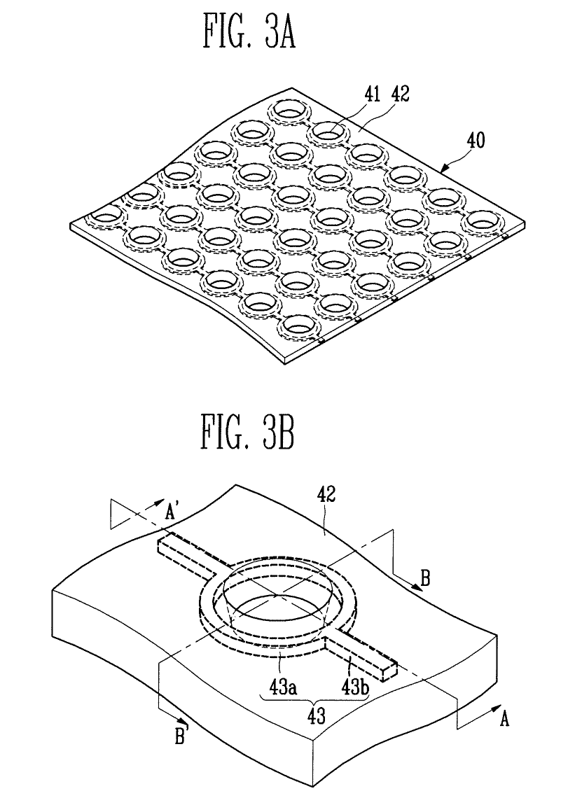

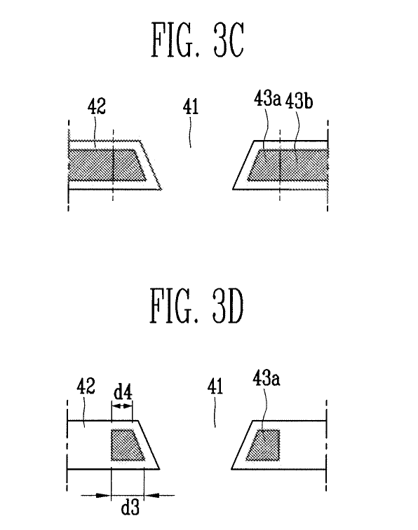

With reference to FIGS. 3A to 3D, the second electrode sheet 40 includes a second dielectric layer 42 and a second discharge electrode 43. The second dielectric layer 42 is a layer for burying (or covering) the second discharge electrode 43 therein, and has the above-mentioned second discharge holes 41. The second dielectric layer 42 is composed of a metal oxide (MxOy) (e.g., Al₂O₃).

The second discharge electrode 43 is composed of a second discharge unit 43a and a second connection unit 43b. In one embodiment, the second discharge unit 43a is configured as a closed curve, wherein the closed curve surrounds one of the second discharge holes 41. The second connection unit 43b is configured to connect the second discharge units 43a, to receive a power from an external power source, and to supply the received external power source to the second discharge electrode 43.

In one embodiment, the second discharge electrode 43 is composed of the same metal as the metal (M) of the metal oxide (MxOy) which is a material of the second dielectric layer 42. Also, according to one embodiment, a plurality of the second discharge electrodes 43 are generally extended in a direction different from (or crossing) the extension direction of the first discharge electrodes 33.

As described above, each of the first electrode sheet 30 (including a first discharge electrode 33 and a dielectric layer 32) and the second electrode sheet 40 (including a second discharge electrode 43 and a dielectric layer 42) is, in one embodiment of the present invention, a one-piece sheet formed through an anodizing process.

The first electrode sheet 30 includes a first surface in contact with the rear glass substrate 10 and a second surface in contact with the second electrode sheet 40. A discharge unit 33a of the first discharge electrode 33 is within the interior of the first electrode sheet 30. Here, an area (d1) of the first surface of the first electrode sheet 30 is larger in area than an area (d2) of the second surface where the discharge unit 33a of the first discharge electrode 33 is in communication (or contact) with the second surface.

In the described embodiment, the second electrode sheet 40 also includes a first surface in contact with the first electrode sheet 30 and a second surface in contact with the front glass substrate. A discharge unit 43a of the second discharge electrode 43 is within the interior of the second electrode sheet 40. Here, an area (d3) of the first surface of the second electrode sheet 40 is larger in area than an area (d4) of the second surface where the discharge unit 33a of the first discharge electrode 33 is in communication (or contact) with the second surface. In one embodiment, the upper surface area (d4) of the second discharge electrode 43 (or the second electrode sheet (40)) and the lower surface area (d1) of the first discharge electrode 33 (or the first electrode sheet (30)) are formed having a ratio ranging from about 0.3:1 to about 0.9:1. In another embodiment, the upper surface area (d4) of the second discharge electrode 43 (or the second electrode sheet (40)) and the lower surface area (d1) of the first discharge electrode 33 (or the first electrode sheet (30)) are formed having a ratio of about 0.5:1. For example, in the case of a 50-inch plasma display panel, the upper surface area (d4) of the second discharge electrode 43 may be formed having a width of about 200 μm, and the lower surface area (d1) of the first discharge electrode 33 may be formed having a width of about 100 μm.

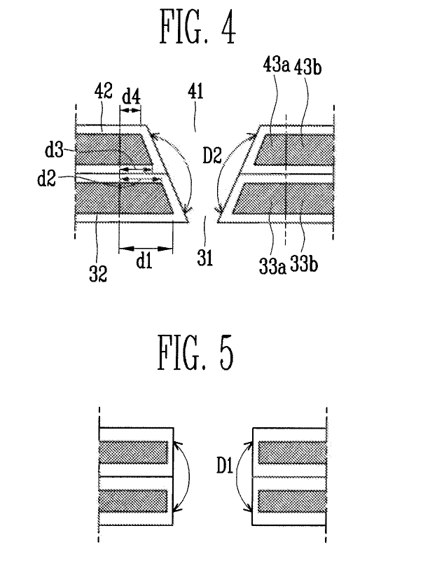

As such, the described embodiment is configured such that a vacuum ultra violet (VUV) emission by a long gap effect may be increased by forming the first discharge electrode 33 and the second discharge electrode 43 obliquely to extend a distance from a first surface (or lower surface) of the first discharge electrode 33 to a second surface (or upper surface) of the second discharge electrode 43 to form a main discharge path (D2) at a longer length than a main discharge path (D1) of a comparative plasma display panel (see FIGS. 4-5) which is formed of a first discharge electrode and a second discharge electrode having no extrusion formed therein. In addition, the intensity of light is enhanced by UV radiation with an increasing volume (a discharge mode) of an internally formed plasma, the light being able to reach a phosphor. Also, it is possible to reduce an invalid power consumption of a panel by lengthening the main discharge path to lower an electric capacity of the panel.

Here, in one embodiment, the upper surface of the first discharge hole 31 is formed to have a larger diameter than the lower surface of the second discharge hole 41, and therefore it is possible to enhance transmissivity of a visible ray to an upper portion of the first discharge hole 31 corresponding to a line of sight of a viewer. Also, an aperture ratio of the front glass substrate may be significantly increased and the transmissivity of a visible ray may be improved since a discharge electrode or a bus electrode formed using an indium tin oxide (ITO) film and a dielectric layer formed in the front glass substrate to cover the discharge electrode and the bus electrode, which are all present in the front glass substrate of a comparative plasma display panel, are not present in the front glass substrate of the plasma display panel according to an above described embodiment of the present invention.

Also, according to one experiment, if the first surface of the first discharge electrode 33 and the discharge unit of the second discharge electrode 43 are extended from about 50 μm to about 100 μm, then an electric current is increased by two times and a luminance is increased by four times, thereby obtaining a synergic effect as much as two times.

Hereinafter, a method of manufacturing an electrode sheet according to an embodiment of the present invention using a metal anodizing process will be described in more detail.

The term “metal anodizing” refers to a method in which a thin oxide film is formed on a surface of a metal to protect the inside of the metal. The oxide film is applied to a metal that can form an oxide film on its surface by itself since it is mainly a metal having a high reactivity to oxygen, such as aluminum (Al) and/or one or more of its alloys. The metal anodizing method artificially forms an oxide film having a substantially uniform (and/or constant) thickness by accelerating an oxidation reaction in the metal surface so that the metal can serve as an anode in a certain solution (e.g., sulfuric acid).

Accordingly, if a metal having a set (or predetermined) thickness is exposed to an anodizing solution having a set (or predetermined) density for a set (or predetermined) time, the exposed region is oxidized to lose metal properties, and therefore a surface of the metal becomes a dielectric material that loses an electrical conductivity, but the inside of the metal is still not oxidized.

According to the described embodiment, a metal anodizing process as described above is used to manufacture an electrode sheet.

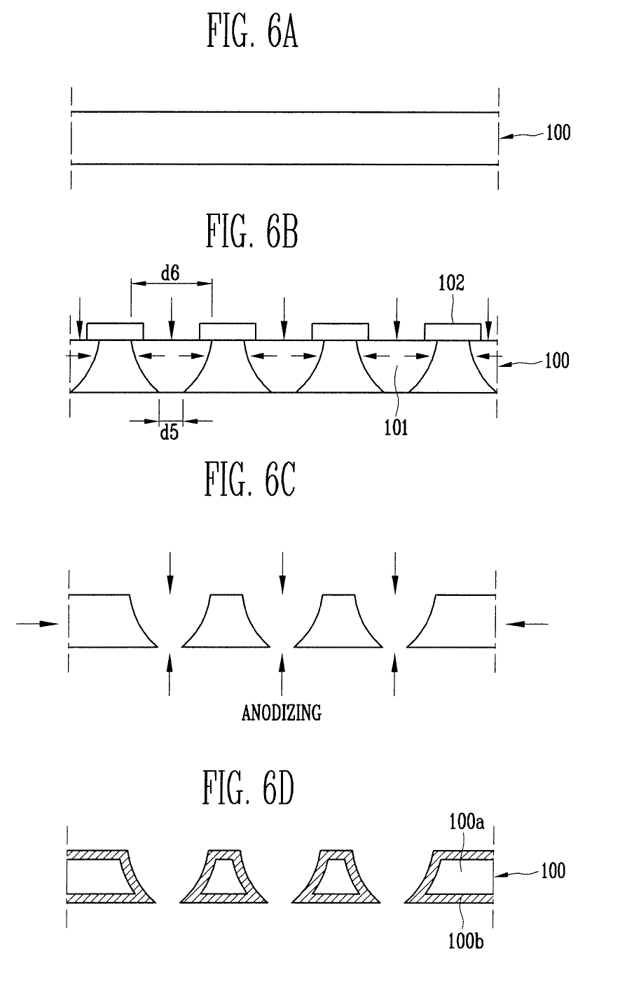

FIGS. 6A to 6D are perspective schematics illustrating a method of manufacturing an electrode sheet for a plasma display panel according to an embodiment of the present invention.

With reference to FIG. 6A, the method includes preparing a metal sheet 100. In one embodiment, the metal sheet 100 has a thickness of between about 10 μm and about 200 μm.

FIG. 6B illustrates a task of forming at least one discharge hole 101 on the metal sheet 100. In one embodiment, the metal sheet 100 is etched to form the at least one discharge hole 101.

In order to form the at least one discharge hole 101 having a reverse-tapered shape, a protective film 102, such as dry film resistor (DFR), is attached to partially cover an area of a front surface of metal sheet corresponding to the at least one discharge hole 101, and an etching solution is applied to the front surface of the metal sheet 100 to etch a region of the metal sheet 100 where the protective film 102 is not attached. More particularly, if the etching solution is applied to the front surface of the metal sheet 100, the front surface of the metal sheet 100 has a higher etching ratio than a rear surface of the metal sheet 100. Therefore, a diameter (d6) of the at least one discharge hole 101, formed in the front surface of the metal sheet 100 coated with the etching solution, is larger than a diameter (d5) of the at least one discharge hole 101 formed in the rear surface of the metal sheet 100.

With further reference to FIG. 6B, the at least one discharge hole 101 may be formed having a reverse-tapered spherical shape (e.g., by controlling an etching time), a configuration which may be suitable varied by those skilled in the art.

FIG. 6C illustrates a subsequent task of anodizing the metal sheet 100 having the at least one discharge hole 101 formed therein.

With reference to FIG. 6D, another task includes removing the protective film 102 from the metal sheet 100, which is divided into a region 100b which is anodized to become a dielectric and a region 100a which is not anodized to remain as a metal. The front surface of the metal sheet 100 is anodized to form a surface of the metal sheet 100 as the dielectric layer 100b, and a region that is not anodized within the interior of the metal sheet 100 is utilized to form the discharge electrode 100a. Finally, the electrode sheet 100 is manufactured such that a lower surface of the discharge electrode 100a has a wider area than an upper surface of the discharge electrode 100a within the interior of the metal sheet 100, as shown in FIG. 6D.

The description proposed herein is an example for the purpose of illustration only, and is not intended to limit the scope of the invention. It is therefore to be understood that the detailed description and specific examples described herein, while indicating certain embodiments of the invention, are given by way of illustration only, since various changes and modifications within the spirit and scope of the invention will become apparent to those skilled in the art from this detailed description. For example, the discharge cell of the plasma display panel according to an embodiment of the present invention may further include a protective layer composed of MgO, etc. like the conventional displays.

Embodiments of an electrode sheet for a plasma display panel according to the present invention may be utilized to simplify a configuration of a plasma display device and enhance a VUV emission by the long gap effect by extending a distance between the discharge units. Also, an electrode sheet for a plasma display panel according to an embodiment of the present invention may be utilized to reduce invalid power consumption due to the electric capacity of the panel.

Also, embodiments of a method of manufacturing an electrode sheet according to the present invention may be utilized to manufacture an electrode sheet having the same configuration in a much easier manner.

Also, embodiments of a method of manufacturing an electrode sheet according to the present invention may be utilized to significantly increase an aperture ratio of the plasma display panel and improve transmissivity of a visible ray.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode sheet for a plasma display panel, the electrode sheet comprising:
a dielectric layer having a first surface and a second surface and including a discharge hole for providing a side wall of a discharge space, the dielectric layer being composed of metal oxide (MxOy); and
a discharge electrode including a discharge unit around a perimeter of the discharge hole and a connection unit for connecting the discharge unit and another discharge unit to each other, the discharge electrode being within the dielectric layer and composed of metal (M) of the metal oxide (MxOy),
wherein the discharge unit of the discharge electrode is within the dielectric layer such that the first surface of the dielectric layer has an area differing from that of the second surface of the dielectric layer.

2. The electrode sheet for a plasma display panel according to claim 1, wherein a first surface of the discharge electrode corresponding to the first surface of the dielectric layer is larger in area than that of a second surface of the discharge electrode corresponding to the second surface of the dielectric layer.

3. The electrode sheet for a plasma display panel according to claim 1, wherein the discharge hole has a reverse-tapered shape.

4. The electrode sheet for a plasma display panel according to claim 1, wherein the metal (M) is selected from the group consisting of aluminum and its alloys.

5. The electrode sheet for a plasma display panel according to claim 1, wherein the connection unit and the discharge unit of the discharge electrode have substantially the same thickness.

6. The electrode sheet for a plasma display panel according to claim 1, wherein the first surface of the dielectric layer is a lower surface of the dielectric layer, and the second surface of the dielectric layer is an upper surface of the dielectric layer.

7. A plasma display panel, comprising:
a rear glass substrate;
a front glass substrate facing and spaced from the rear glass substrate at a substantially constant distance;
a first electrode sheet comprising:
a first dielectric layer between the rear glass substrate and the front glass substrate and including a first discharge hole for providing a side wall of a discharge space, the first dielectric layer being composed of metal oxide (MxOy), and
a first discharge electrode within the first dielectric layer and including a first discharge unit around a perimeter of the first discharge hole and a first connection unit for connecting the first discharge unit and another first discharge unit to each other, the first discharge electrode being composed of metal (M) of the metal oxide (MxOy); and
a second electrode sheet comprising:
a second dielectric layer between the first electrode sheet and the front glass substrate and including a second discharge hole arranged in a facing region to correspond to the first discharge hole, the second discharge hole being also for providing the side wall of the discharge space, and
a second discharge electrode within the second dielectric layer and including a second discharge unit around a perimeter of the second discharge hole and a second connection unit for connecting the second discharge unit and another second discharge unit to each other, the second discharge electrode being composed of metal (M) of the metal oxide (MxOy),
wherein a lower surface of the first electrode sheet adjacent to the rear glass substrate has a larger area than an upper surface of the first electrode sheet adjacent to the second dielectric layer,
wherein a lower surface of the second electrode sheet adjacent to the first dielectric sheet has a smaller area than the upper surface of the first electrode sheet, and
wherein an upper surface of the second electrode sheet has a smaller area than the lower surface of the second electrode sheet.

8. The plasma display panel according to claim 7, wherein at least one of the first discharge hole or the second discharge hole has a reverse-tapered shape.

9. The plasma display panel according to claim 7, wherein a ratio of the area of the upper surface of the second electrode sheet and the area of the lower surface of the first electrode sheet ranges from about 0.3:1 to about 0.9:1.

10. The plasma display panel according to claim 9, wherein the ratio of the area of the upper surface of the second electrode sheet and the area of the lower surface of the first electrode sheet is about 0.5:1.

11. The plasma display panel according to claim 7, wherein the first dielectric layer and the second dielectric layer are metal oxides (MxOy) of the metal (M).

12. The plasma display panel according to claim 7, wherein the metal (M) of the first discharge electrode is selected from the group consisting of aluminum and its alloys.

13. The plasma display panel according to claim 7, wherein the metal (M) of the second discharge electrode is selected from the group consisting of aluminum and its alloys.

14. The plasma display panel according to claim 7, wherein the first connection unit and the first discharge unit of the first discharge electrode have substantially the same thickness.

15. The plasma display panel according to claim 7, wherein each of the first discharge hole and the second discharge hole has a reverse-tapered shape.

16. A method of manufacturing an electrode sheet for a plasma display panel including a discharge electrode within a dielectric layer, the discharge electrode including a discharge hole, a discharge unit around a perimeter of the discharge hole, and a connection unit for connecting the discharge unit and another discharge unit to each other, the discharge unit being formed so that a first surface of the discharge electrode has an area differing from that of a second surface of the discharge electrode, the method comprising:
providing a metal sheet;
attaching a protective film for forming a pattern of the discharge electrode to one surface of the metal sheet;
forming the discharge hole on the metal sheet, the discharge hole having a reverse-tapered shape;
anodizing the metal sheet to form the discharge electrode with the dielectric layer and having the first surface with a first surface area and the second surface with a second surface area; and
detaching the protective film.

17. The method of manufacturing an electrode sheet for a plasma display panel according to claim 16, wherein the forming the discharge hole on the metal sheet comprises etching from the one surface of the metal sheet where the protective file of the metal sheet is attached to form the discharge hole having the reverse-tapered shape.
